(19) United States
(12) Patent Application Publication
(10) Pub. No.: US 2026/0154683 A1
(43) Pub. Date: Jun. 4, 2026

(54) SYSTEMS AND METHODS FOR SECURELY RETRIEVING A PRIMARY ACCOUNT NUMBER THROUGH THE OPEN BANKING INFRASTRUCTURE

(71) Applicant: Mastercard International Incorporated, Purchase, NY (US)

(72) Inventors: Skyler Fox, Park Ridge, NJ (US); Shawn Mehrhoff, Sappington, MO (US)

(73) Assignee: Mastercard International Incorporated, Purchase, NY (US)

(21) Appl. No.: 18/968,665

(22) Filed: Dec. 4, 2024

(51) Int. Cl. G06Q 20/40; G06Q 40/02

(52) U.S. Cl. CPC G06Q 20/401; G06Q 40/02

(57) ABSTRACT

A computing system enables retrieval of a device primary account number (dPAN) via open banking, utilizing an open banking system, a token requester server system, and a token service system. The process begins with a financial application on a cardholder's device requesting financial account information and prompting the open banking system to launch a login interface for authentication of the cardholder by the financial account issuer. Upon successful authentication, an authorization code is issued, converted into an authorization token, and sent with account details to the token requester server system. The token requester server system then submits a payment token request to the issuer, which returns a token account receipt. The token service system subsequently processes the receipt to generate the device primary account number (dPAN) and returns the dPAN to the token requester server system.

### BACKGROUND

The field of the disclosure relates to open banking and, more specifically, to a computing system and method that facilitate secure retrieval of a device primary account number (dPAN) through the open banking infrastructure.

In the current open banking framework, data requestors are restricted to retrieving limited account details, such as account numbers and routing transit numbers (AN/RTN) for checking or savings accounts. This restriction inherently constrains the availability of multi-rail payment options, as data requestors lack access to the broader range of account identifiers necessary to initiate payments across diverse financial networks, such as card-based networks. Additionally, the absence of a mechanism for retrieving PANs introduces operational friction, as it prevents users and third parties from leveraging alternative payment channels that rely on PANs for transaction processing.

The current open banking ecosystem is designed to offer consumers and businesses increased control over financial data sharing, promoting transparency, security, and streamlined account integration. However, the limitations surrounding account details retrieval have posed obstacles in scenarios where a primary account number (PAN) is essential for accessing specific payment networks, such as card-based payment rails, or where an enhanced user experience relies on seamless data transitions between financial products. Without access to the PAN, entities utilizing open banking connections must often resort to supplementary authentication and verification methods, thereby introducing additional steps in transaction flows and elongating the customer interaction process.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computing system is provided. The computing system includes an open banking system having one or more first processors and a first memory. The first memory includes first executable instructions, that when executed by the one or more first processors, cause the one or more first processors to receive a connection request signal from a financial application running on a cardholder computing device associated with a cardholder. The connection request signal includes one or more claims detailing financial account information being requested for a financial account associated with the cardholder. In response to the connection request signal, the one or more first processors launch an open banking connection interface on the cardholder computing device, via the financial application. In addition, the one or more first processors present, via the open banking connection interface, a login screen associated with an issuer of the financial account. The one or more first processors receive, from the financial application, an authorization code. The authorization code includes a verification that the cardholder is authenticated by the issuer. Additionally, the one or more first processors generate an authorization token based on the authorization code. The computing system also includes a token requester server system having one or more second processors and a second memory. The second memory includes second executable instructions, that when executed by the one or more second processors, cause the one or more second processors to receive, from the open banking system, the authorization token and the financial account information associated with the financial account. Utilizing the authorization token, the one or more second processors transmit a payment token request to the issuer. The payment token request includes a token requester identifier (TRID) associated with the token requester server system, the authorization token, and the financial account information. Furthermore, the one or more second processors receive, from the issuer, a token account receipt. The computing system further includes a token service system having one or more third processors and a third memory. The third memory includes third executable instructions, that when executed by the one or more third processors, cause the one or more third processors to receive a token account receipt request from the issuer. The token account receipt request includes the TRID and the financial account information. The one or more third processors also generate the token account receipt and transmit the token account receipt to the issuer. Furthermore, the one or more third processors generate a device primary account number (dPAN). The one or more second processors transmit a payment token request to the token service system. The payment token request includes the token account receipt. In response, the one or more third processors receive the dPAN from the token service system.

In another aspect, a method is provided. The method is performed by a computing system that includes an open banking system, a token requester server system, and a token service system. The method includes receiving, by the open banking system, a connection request signal from a financial application running on a cardholder computing device associated with a cardholder. The connection request signal includes one or more claims detailing financial account information being requested for a financial account associated with the cardholder. The method also includes, in response to the connection request signal, launching, by the open banking system, an open banking connection interface on the cardholder computing device, via the financial application. Furthermore, the method includes presenting, by the open banking system via the open banking connection interface, a login screen associated with an issuer of the financial account. The method includes receiving, by the open banking system from the financial application, an authorization code. The authorization code includes a verification that the cardholder is authenticated by the issuer. Moreover, the method includes generating, by the open banking system, an authorization token based on the authorization code. In addition, the method includes receiving, by the token requester server system from the open banking system, the authorization token and the financial account information associated with the financial account. Furthermore, the method includes, utilizing the authorization token, transmitting, by the token requester server system, a payment token request to the issuer. The payment token request includes a token requester identifier (TRID) associated with the token requester server system, the authorization token, and the financial account information. Additionally, the method includes receiving, by the token requester server system from the issuer, a token account receipt. The method includes receiving, by the token service system, a token account receipt request from the issuer. The token account receipt request includes the TRID and the financial account information. Moreover, the method includes generating, by the token service system, the token account receipt and transmitting the token account receipt to the issuer. Furthermore, the method includes generating, by the token service system, a device primary account number (dPAN) and transmitting a payment token request to the token service system. The payment token request includes the token account receipt. The method also includes, in response, receiving, by the token requester server system, the dPAN from the token service system.

In yet another aspect, a non-transitory computer-readable storage media is provided. The non-transitory computer-readable storage media includes computer-executable instructions stored thereon, that when executed by one or more processors, cause the one or more processors to receive, by an open banking system, a connection request signal from a financial application running on a cardholder computing device associated with a cardholder. The connection request signal includes one or more claims detailing financial account information being requested for a financial account associated with the cardholder. The executable instructions cause the one or more processors to, in response to the connection request signal, launch, by the open banking system, an open banking connection interface on the cardholder computing device, via the financial application. Furthermore, the executable instructions cause the one or more processors to present, by the open banking system via the open banking connection interface, a login screen associated with an issuer of the financial account. Additionally, the executable instructions cause the one or more processors to receive, by the open banking system from the financial application, an authorization code. The authorization code includes a verification that the cardholder is authenticated by the issuer. The executable instructions also cause the one or more processors to generate, by the open banking system, an authorization token based on the authorization code. Furthermore, the executable instructions cause the one or more processors to receive, by a token requester server system from the open banking system, the authorization token and the financial account information associated with the financial account. Moreover, the executable instructions cause the one or more processors to, utilizing the authorization token, transmit, by the token requester server system, a payment token request to the issuer. The payment token request includes a token requester identifier (TRID) associated with the token requester server system, the authorization token, and the financial account information. Additionally, the executable instructions cause the one or more processors to receive, by the token requester server system from the issuer, a token account receipt. The executable instructions also cause the one or more processors to receive, by a token service system, a token account receipt request from the issuer. The token account receipt request includes the TRID and the financial account information. The executable instructions cause the one or more processors to generate, by the token service system, the token account receipt. In addition, the executable instructions cause the one or more processors to transmit, by the token service system, the token account receipt to the issuer. Furthermore, the executable instructions cause the one or more processors to generate, by the token service system, a device primary account number (dPAN). Additionally, the executable instructions cause the one or more processors to transmit, by the token requester server system, a payment token request to the token service system. The payment token request includes the token account receipt. In response, the executable instructions cause the one or more processors to receive, by the token requester server system, the dPAN from the token service system.

A variety of additional aspects will be set forth in the detailed description that follows. These aspects can relate to individual features and to combinations of features. Advantages of these and other aspects will become more apparent to those skilled in the art from the following description of the exemplary embodiments that have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party network system including a cardholder computing device belonging to a cardholder (or consumer), in accordance with one embodiment of the present disclosure;

FIG. 2 is an example configuration of the cardholder computing device shown in FIG. 1 that may be operated by a cardholder shown in FIG. 1;

FIG. 3 is an example configuration of a computing system for use in the network system shown in FIG. 1;

FIG. 4 is an example configuration of a server system for use in the network system shown in FIG. 1; and

FIG. 5 depicts a flowchart illustrating various example actions performed by components of the network system shown in FIG. 1 to obtain a primary account number for an open-banking linked account.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

Broadly, the present invention describes a novel method for the retrieval of a primary account number (PAN) associated with an open banking-linked financial account, alongside the existing provision of the account number and routing transit number (AN/RTN). Through a single, user-permissioned connection, the present invention enables authorized requestors to obtain both the PAN and the AN/RTN of an account, such as checking and credit card accounts. This enhances the versatility of data usage across multiple payment networks by streamlining access to these identifiers under a unified open banking framework.

The technical advantages include the ability to mitigate current frictions in financial transactions and broaden the functionality of open banking-linked accounts by enabling data requestors to initiate payments across multiple payment rails seamlessly. Consequently, this invention not only improves data accessibility but also aligns with industry trends favoring interoperable, flexible financial solutions in digital finance ecosystems. By providing a dual credential retrieval capability, the present invention optimizes the utility of open banking connections, which addresses a significant operational need within the financial technology and payment processing industry.

### Exemplary System

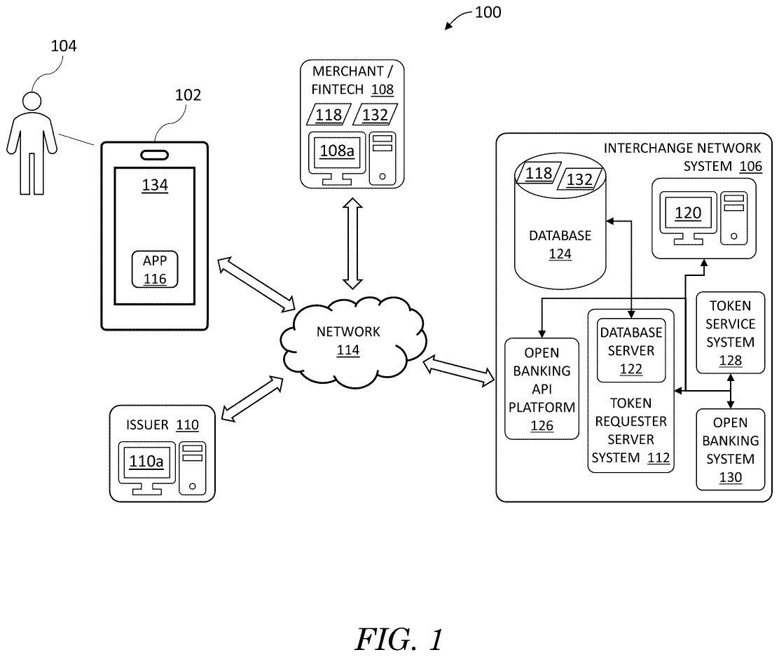

FIG. 1 is a block diagram of an example multi-party network system 100, including a cardholder computing device 102 (e.g., a mobile computing device) belonging to a cardholder (or consumer) 104, in accordance with one embodiment of the present disclosure. In the exemplary embodiment, the network system 100 provides interchange network services offered by one or more payment networks, such as interchange network system 106. In addition, the network system 100 enables financial data transactions and services related to cardholder financial accounts and transaction cards in which the cardholder 104, a merchant/fintech 108, and a card issuer 110 do not need to have a one-to-one relationship. Embodiments described herein relate to transaction card systems, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. Although parts of the network system 100 are presented in one arrangement, other embodiments may include the same or different parts arranged otherwise, depending, for example, on authentication and consent processes, communication between computing devices, etc.

It is noted that merchants and fintechs, such as the merchant/fintech 108, provide cardholders, such as the cardholder 104, with goods and services and/or access to new products and services related to a cardholder's financial accounts. The merchants/fintechs include, for example, retail merchants, account information service providers (AISPs), payment initiation service providers (PISPs), etc. In order for the merchants/fintechs to provide goods and services and/or account services to a cardholder, the merchants/fintechs require access to the cardholder's financial account information.

In the example embodiment, the network system 100 generally includes the cardholder computing device 102, the interchange network system 106, the merchant/fintech 108 (via a merchant/fintech computing device 108a), and the issuer 110 (via an issuer computing device 110a) coupled in communication via a communications network 114. The interchange network 106 includes a token requester server system 112, one or more payment network server systems 120, a database 124, a token service system 128, and an open banking system 130.

The network 114 includes, for example and without limitation, one or more of a local area network (LAN), a wide area network (WAN) (e.g., the Internet, etc.), a mobile network, a virtual network, and/or any other suitable public and/or private network capable of facilitating communication among the cardholder computing device 102, the interchange network system 106, the merchant/fintech 108, and/or the issuer 110. In some embodiments, the network 114 includes more than one type of network, such as a private transaction network provided by the interchange network system 106 to the merchant/fintech 108 and the issuer 110, and, separately, the public Internet, which may facilitate communication between the cardholder computing device 102, the merchant/fintech 108, the issuer 110, and/or the interchange network system 106, etc.

The cardholder computing device 102 (e.g., a smartphone or other computing device used by the cardholder 104) includes a user interface 134 that facilitates user interaction with the cardholder computing device 102. For example, and without limitation, the user interface 134 enables the cardholder 104 to input information or data to the cardholder computing device 102. The user interface 134 also enables the cardholder computing device 102 to present (e.g., output) information or data to the cardholder 104 (e.g., on a display of the cardholder computing device 102). The user interface 134 includes, for example, one or more merchant/fintech applications 116 (broadly, a merchant/fintech app), which is installed on the cardholder computing device 102.

In the exemplary embodiment, the merchant/fintech app 116 provides communication to the merchant/fintech 108 (via the merchant/fintech computing device 108a). It is contemplated that fewer or more merchant/fintech apps may be installed on the cardholder computing device 102 and displayed by the user interface 134, where each merchant/fintech app is associated with at least one financial service provider (e.g., the merchant/fintech 108).

In the exemplary embodiment, the cardholder computing device 102 communicates with one or more of the merchant/fintech 108 (via the merchant/fintech computing device 108a) and the issuer 110 (via the issuer computing device 110a), for example, via the network 114. In addition, the cardholder computing device 102 communicates with the token requester server system 112, for example, via the network 114, to exchange and/or synchronize authentication, consent, and/or financial account data via the merchant/fintech app 116. The token requester server system 112 accesses the network 114 to communicate with the cardholder computing device 102, the merchant/fintech 108, and the issuer 110 to facilitate the generation of one or more digital primary account numbers (dPANs) 118, and the exchange of cardholder financial account data between the merchant/fintech 108 and the issuer 110.

The cardholder computing device 102 can be any computing device capable of interconnecting to the network 114, such as the Internet, including a desktop computer, laptop, mobile web-based device, smartphone, PDA, or other mobile web-based connectable equipment. The cardholder computing device 102 is interconnected to the Internet through one or more interfaces including a network, such as a local area network (LAN) or a wide area network (WAN), dial-in-connections, cable modems, wireless modems, and special high-speed ISDN lines. In addition, in the example embodiment, the cardholder computing device 102 is configured to communicate with other cardholder computing devices (not shown) and/or merchant point-of-sale (POS) systems (not shown) using various forms of communication including, for example, radio frequency communication, near field communication (NFC), network-based communication, and the like.

In the exemplary embodiment, the payment network server system 120 (also referred to as a payment system) is part of the interchange network system 106 and is coupled in communication to the network 114. The payment system 120 is a computing system including, for example, a web application server, an application programming interface (API) server, and a memory device, enabling the interchange network system 106 to be in communication with the token requester server system 112 using, for example, and without limitation, an internal network and/or the Internet. The payment system 120 is interconnected to the Internet through one or more interfaces including a network, such as a local area network (LAN) or a wide area network (WAN), dial-in-connections, cable modems, and special high-speed ISDN lines. The payment system 120 can be any computing device capable of interconnecting to the Internet. In certain embodiments of the present invention, the token requester server system 112 is integrated with or is otherwise a part of the payment network server system 120.

The token requester server system 112 includes, for example, a database server 122, which is connected to the database 124. In one embodiment, the database 124 is stored on the token requester server system 112. In an alternative embodiment, the database 124 may be stored remotely from the token requester server system 112 and/or may be non-centralized. The database 124 is configured to receive and store, at least, one or more dPANs 118, account data and/or information associating respective dPANs 118 to respective cardholder accounts, cardholder consent data associated with the respective dPANs 118, and/or other data or information associated with the dPANs 118 (e.g., token status, expiry date, authorized merchant/fintech, etc.).

Furthermore, the token requester server system 112 may interface with an open service application programming interface (API) platform 126 of the interchange network 106. In the exemplary embodiment, the open service API platform 126 facilitates the creation of the dPAN 118 for the merchant/fintech 108. In certain embodiments, the open service API platform 126 also facilitates obtaining cardholder consent for creating the dPAN 118, obtaining cardholder account data, and authenticating the cardholder 104. The open service API platform 126 facilitates storing the dPANs 118 and associated data or information in the database 124, for example, via the database server 122.

In an example embodiment, the cardholder computing device 102 is used to run the merchant/fintech app 116, which establishes a connection with an associated merchant/fintech 108, for example, via the network 114. The merchant/fintech 108 may offer goods/services for sale and/or provide financial services to the cardholder 104 via the merchant/fintech app 116. To complete payment transactions and/or provide the financial services, the merchant/fintech 108 may require access to certain cardholder financial account data (e.g., account and routing numbers, transaction alerts, transaction history, etc.) that is stored or held by the interchange network system 106. However, because the cardholder financial account data belongs to the cardholder, it is generally only shared with the issuer of the cardholder's financial account, such as the issuer 110. To gain access to the cardholder financial account data, the merchant/fintech 108 must receive consent from the cardholder 104.

The embodiments illustrated and described herein as well as embodiments not specifically described herein but within the scope of aspects of the invention constitute exemplary means for generating and providing a payment token, such as the dPAN 118, to a third party provider, such as the merchant/fintech 108, via open banking. In current open banking systems, access to such a payment token, such as the dPAN 118, is unavailable because open banking services are performed using the ACH network, which is independent of a traditional payment card network. The cardholder computing device 102, the token requester server system 112, the token service system 128, or any other similar computer device(s), specially programmed with computer-executable instructions to execute processes and techniques with a processor as described herein, constitute exemplary means for enabling a cardholder, such as the cardholder 104, to provide his or her financial account data via open banking to a third party provider (e.g., the merchant/fintech 108) and consent to the third party provider receiving a payment token associated with the cardholder's financial account. The merchant/fintech 108 may use the dPAN 118 or the open banking account data to perform transactions using either a payment card network or an open banking network (e.g., the ACH network). This increases the efficiency of the merchant/fintech computing device 108a when performing transactions with the cardholder 104, for example, by providing a transaction option otherwise unavailable to the merchant/fintech computing device 108a. In instances where one of the payment card network or the open banking network is experiencing increased network latency, the merchant/fintech computing device 108a may select the more efficient network in order to complete a transaction.

### Exemplary Computer Systems

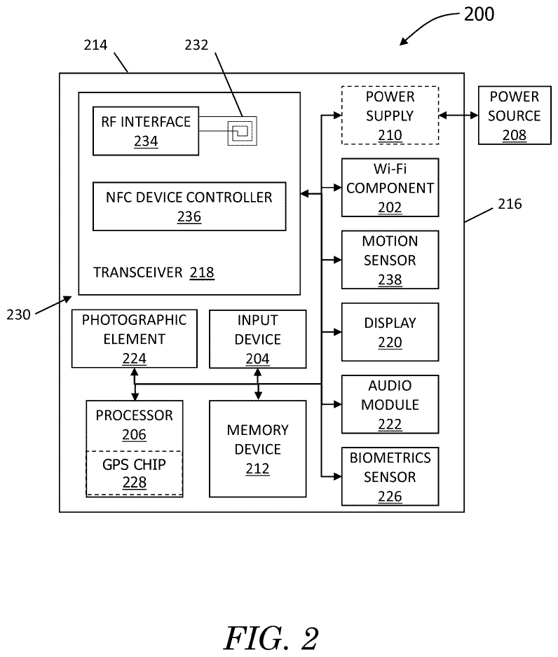

FIG. 2 is an example configuration of a user computing system 200, such as the cardholder computing device 102 (shown in FIG. 1), that may be operated by a user, such as the cardholder 104 (shown in FIG. 1). In the exemplary embodiment, the user computing system 200 is a computing device configured to connect to one or more of the merchant/fintech 108 (shown in FIG. 1), the issuer 110 (shown in FIG. 1), the token requester server system 112 (shown in FIG. 1), and any other computing devices, such as other user computing systems (not shown).

In the exemplary embodiment, the user computing system 200 generally includes a processor 206, a memory device 212, a transceiver 218 (or a wireless communication device), a photographic element 224, and a biometrics sensor 226. In addition, the user computing system 200 includes an integrated Wi-Fi component 202 (e.g., implementing the Institute of Electrical and Electronics/IEEE 802.11 family of standards), an input device 204, a display 220, and an audio module 222. Moreover, the user computing system 200 includes an internal power supply 210 (e.g., a battery or other self-contained power source) to receive power, or alternatively, in some embodiments, the user computing system 200 may include an external power source 208. Optionally, the user computing system 200 may include a motion sensor 238.

The processor 206 includes one or more processing units (e.g., in a multi-core configuration) specially programmed for executing computer readable instructions. The computer readable instructions may be executed within a variety of different operating systems (OS) on the cardholder computing device 102, such as UNIX, LINUX, Microsoft Windows®, etc. More specifically, the computer readable instructions may cause various data manipulations on data stored in the memory device 212 (e.g., create, read, update, and delete procedures). It should also be appreciated that upon initiation of a computer-based method, various computer readable instructions may be executed during initialization. Some operations may be required to perform one or more processes described herein, while other operations may be more general and/or specific to a programming language (e.g., C, C#, C++, Java, or other suitable programming languages, etc.). The memory device 212 is any device allowing information such as the computer readable instructions and/or written works to be stored and retrieved. The memory device 212 includes one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for conducting cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the user computing system 200 may be widely deployed, it may be impractical to manually update software for the user computing system 200. Therefore, the network system 100 preferably provides a mechanism for automatically updating the software on the user computing system 200. For example, an updating mechanism may be used to automatically update any number of components and their drivers, both network and non-network components, including system level (OS) software components. In some embodiments, the user computing system 200 components are dynamically loadable and unloadable; thus, they may be replaced in operation without having to reboot the OS.

A location of the user computing system 200 can be obtained, for example, via a location service (e.g., global positioning system (GPS) service) in the user computing system 200, “ping” data that includes geotemporal data, from cell location register information held by a telecommunications provider to which the user computing system 200 is connected, and the like. For example, in one suitable embodiment, an optional GPS chip 228 can be part of or separate from the processor 206 to enable the location of the user computing system 200 to be determined.

Stored in the memory device 212 are, for example, computer readable instructions for providing a user interface, such as the user interface 134 (shown in FIG. 1), to the user via the display 220 and, optionally, receiving and processing input from the input device 204. A user interface may include, among other possibilities, a web browser and the merchant/fintech app 116 (shown in FIG. 1). Web browsers enable users, such as the cardholder 104, to display and interact with media and other information typically embedded on a web page or a website. The merchant/fintech app 116 allows the user to interact with computers of the merchant/fintech 108 (shown in FIG. 1) and the token requester server system 112 (shown in FIG. 1) to provide financial account details, cardholder consent, and cardholder authentication information thereto.

The photographic element 224 may include a camera or other optical sensor and lens combination capable of generating a video signal and capturing an image. In various embodiments, the photographic element 224 may be integrated in a housing or body, such as a housing 214, of the user computing system 200. When the photographic element 224 captures an image or otherwise generates image data (e.g., video data), the photographic element 224 may store the image data in a data file, either in a raw or compressed format, in the memory device 212.

The biometrics sensor 226 is a biometric input device coupled in communication with at least the processor 206 and the memory device 212. The biometrics sensor 226 enables the user to enter a biometric sample. For example, the biometrics sensor 226 is a hardware component and includes, for example, an integral fingerprint or palm reader/scanner, retinal or iris reader/scanner, camera, and/or voice reader/recorder. The user inputs one or more biometrics and stores them as a biometric profile in the memory device 212. The biometrics of the user, such as the cardholder 104, includes one or more scans or digital representations of physical features of the user that are to be validated/authenticated during generation of the dPAN 118. The biometrics or physical features can include, for example, and without limitation, voice, fingerprint, iris, vein pattern, face, or the like. Feature data from a biometric scan or digital representation may be extracted to select features of interest. The biometric profile may be further stored, for example, by the issuer 110 and/or the interchange network system 106 (shown in FIG. 1) in the database 124 (shown in FIG. 1).

In some embodiments, the motion sensor 238 may include one or more sensor elements that facilitate detecting a person's presence. For example, if the user computing system 200 is operating as the cardholder computing device 102, the motion sensor 238 detects when the cardholder 104 moves or raises the cardholder computing device 102. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the person's presence may be detected by detecting motion using the photographic element 224. The motion sensor 238 may include, for example, and without limitation, sensor elements such as a passive infrared sensor, an ambient light sensor, and the like.

In the example embodiment, the display 220 can include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the user computing system 200 may detect a person's presence by detecting that the person has touched the display 220 of the user computing system 200.

The audio module 222 may include, for example, and without limitation, a speaker and related components capable of broadcasting streaming and/or recorded audio and may also include a microphone. The microphone facilitates capturing audio through the user computing system 200.

In the example embodiment, the user computing system 200 includes the housing 214 at least partly (and more preferably, at least substantially or entirely) enclosing the components described above. In addition, the user computing system 200 includes circuitry 230 configured to communicate with the network 114 (shown in FIG. 1) and/or other computing devices (e.g., other cardholder computing devices, the merchant/fintech 108, the issuer 110, the token requester server system 112, the merchant/fintech 108, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the cardholder computing device 102. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 is fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 is fabricated from any material that enables the user computing system 200 to function as described herein, such as metals, etc.

In one embodiment, the transceiver 218 includes an antenna 232. The antenna 232 includes a looped wire configured to transmit radio signals when current flows through the looped wire. The antenna 232 is any size, shape, and configuration that is suitable for transmitting signals as described herein. For example, the antenna 232 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 is configured to vibrate at a frequency of about 13.56 MHz, which is suitable for use in a near field communication (NFC) system.

In the example embodiment, the antenna 232 transmits radio signals to and receives radio signals from other NFC-enabled computing devices, such as, another cardholder computing device, merchant point-of-sale (POS) systems (not shown), and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 232 functions as an NFC component to send and receive signals. The antenna 232 is configured to transmit radio signals to NFC components positioned within the magnetic field of the antenna 232, such as when the cardholder computing device 102 is located within a predetermined distance of another cardholder computing device and/or a merchant point-of-sale system (not shown). Therefore, the magnetic field generated by the antenna 232 defines the active range of the user computing system 200. Additionally, the antenna 232 receives radio signals from NFC components when the antenna 232 is positioned within the magnetic field of the NFC components.

The transceiver 218 also includes a radio frequency (RF) interface 234 and an NFC device controller 236. The RF interface 234 and the NFC device controller 236 are powered by the power source 208, and in some embodiments, the internal power supply 210 and/or the display 220. In addition, the processor 206 and the memory device 212 are powered in the same manner. The RF interface 234 is configured to receive and transmit RF signals through the antenna 232. The NFC device controller 236 is configured to process the received RF signals and to generate signals to be transmitted by the RF interface 234. The memory device 212 is configured to store data associated with transmitting and receiving the RF signals. The NFC device controller 236 is coupled in communication with the processor 206.

In some embodiments, the user computing system 200 may be connected to one or more peripheral devices (not shown). That is, the user computing system 200 may communicate various data with the one or more peripheral devices. For example, the user computing system 200 may communicate with the one or more peripheral devices through the Wi-Fi component 202, the transceiver 218, or other suitable means.

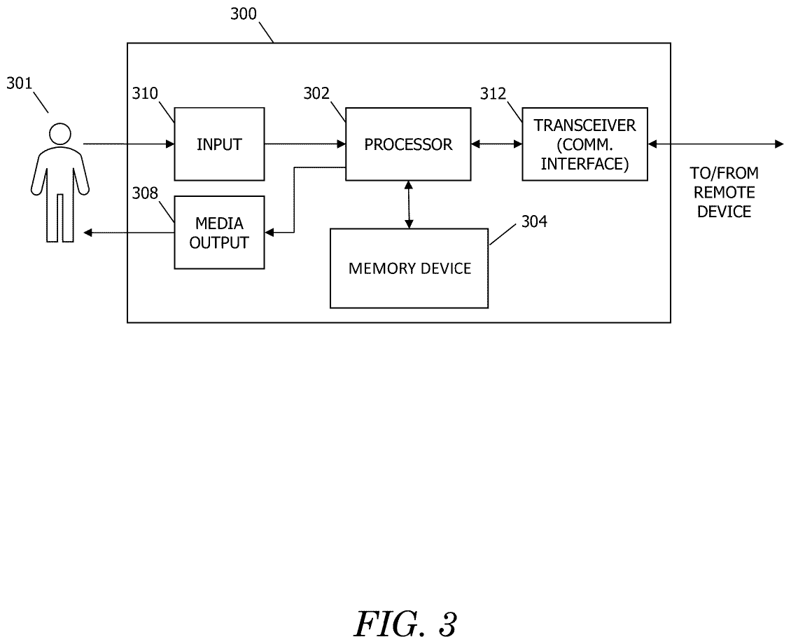

FIG. 3 is an example configuration of a computing system 300 operated by a user 301. In some embodiments, the computing system 300 is a computing system of the merchant/fintech 108 or issuer 110 (each shown in FIG. 1), such as the merchant/fintech computing device 108a or the issuer computing device 110a, respectively (each shown in FIG. 1).

In the example embodiment, the computing system 300 includes one or more processors 302 for executing computer readable instructions. In some embodiments, computer readable instructions are stored in a memory device 304. The processor 302 may include one or more processing units arranged, for example, in a multi-core configuration. The memory device 304 is any device allowing information such as executable instructions, data, and/or written works to be stored and retrieved. The memory device 304 includes one or more computer readable media.

In the example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for conducting cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 300 may be widely deployed, it may be impractical to manually update software for the computing system 300. Therefore, the network system 100 provides a mechanism for automatically updating the software on the computing system 300. For example, an updating mechanism may be used to automatically update any number of components and their drivers, both network and non-network components, including system level (OS) software components. In some embodiments, the computing system 300 components are dynamically loadable and unloadable; thus, they may be replaced in operation without having to reboot the OS.

The computing system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the computing system 300 includes an input device 310 for receiving input from the user 301. The input device 310 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The computing system 300 may also include a transceiver 312 (broadly, a communication interface), which is communicatively connectable to a remote device such as the cardholder computing device 102 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and various software applications. Web browsers enable users to display and interact with media and other information typically embedded on a web page or a website. The various software applications allow the user 301 to interact with the computing system 300 to further communicate with the cardholder computing device 102, the token requester server system 112, etc. to facilitate providing various financial services to the cardholder 104 and, optionally, execute a transaction upon delivery of such services.

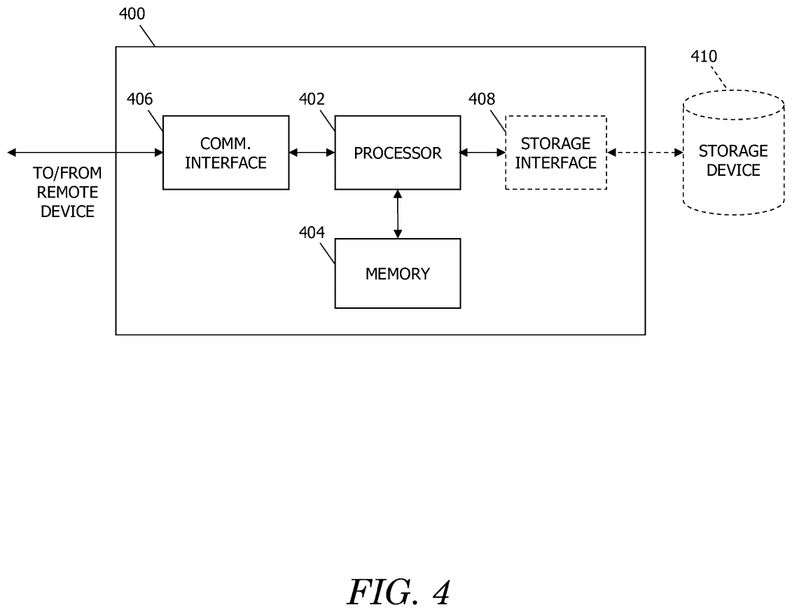

FIG. 4 is an example configuration of a server system 400, such as the token requester server system 112, the payment system 120, the database server 122, the token service system 128, and the open banking system 130 (each shown in FIG. 1). In the example embodiment, the server system 400 includes a processor 402 for executing computer readable instructions. The computer readable instructions may be stored in a memory area 404, for example. The processor 402 includes one or more processing units (e.g., in a multi-core configuration) for executing the computer readable instructions. The computer readable instructions may be executed within a variety of different operating systems on the server system 400, such as UNIX, LINUX, Microsoft Windows®, etc. More specifically, the computer readable instructions may cause various data manipulations on data stored in a storage device 410 (e.g., create, read, update, and delete procedures). It should also be appreciated that upon initiation of a computer-based method, various computer readable instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as cardholder computing device 102, a computing system 300, or another server system. For example, the communication interface 406 may receive communications from the merchant/fintech computing device 108a and/or the issuer computing device 110a.

In the example embodiment, the processor 402 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for conducting cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the server system 400 may be widely deployed, it may be impractical to manually update software for the server system 400. Therefore, the network system 100 provides a mechanism for automatically updating the software on the server system 400. For example, an updating mechanism may be used to automatically update any number of components and their drivers, both network and non-network components, including system level (OS) software components. In some embodiments, the server system 400 components are dynamically loadable and unloadable; thus, they may be replaced in operation without having to reboot the OS.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like the database 124 (shown in FIG. 1). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of a computing system 300, such as the processor 302, the memory device 304, and/or the transceiver 312.

### Exemplary Computer-Implemented Methods

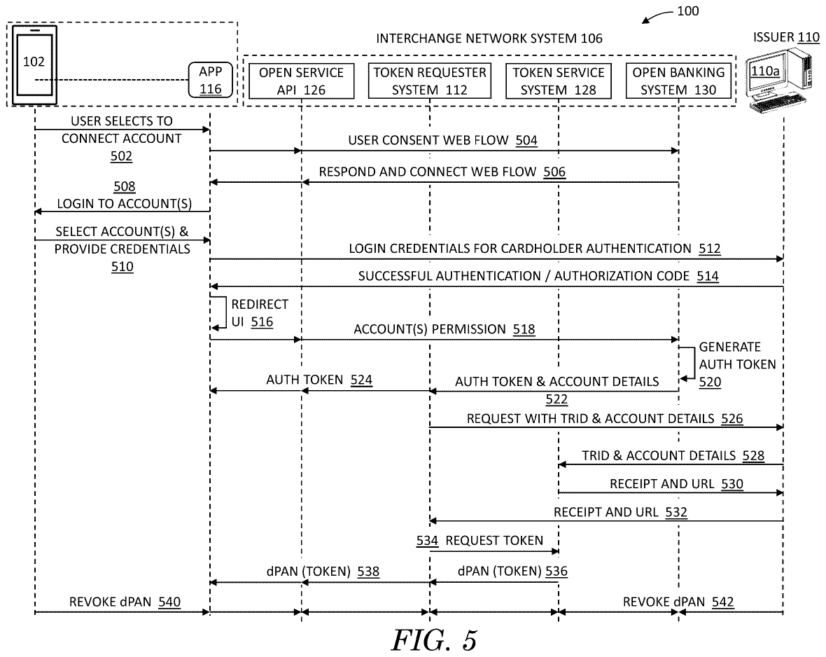

FIG. 5 is a flowchart illustrating various example actions performed by components of the network system 100 to retrieve a payment token, such as the device primary account number (dPAN) 118, for a financial account via open banking. In the example embodiment, the merchant/fintech 108 may or may not have a relationship with the interchange network system 106. Merchants/fintechs that do not have a relationship with the interchange network system 106 may be considered “untrusted,” and as such, the interchange network system 106 fully controls the cardholder experience when a cardholder selects to grant access to his or her financial account data. In such instances, the interchange network system 106, via the open service API platform 126, controls the user interface 134 via one or more applications, lightbox popup windows, etc. presented on the cardholder computing device 102, as described below.

At 502, a computer of the merchant/fintech 108, such as the merchant/fintech computing device 108a, receives an input from the cardholder computing device 102, for example, via the merchant/fintech app 116 over the network 114 (each shown in FIG. 1), indicating that the cardholder, such as the cardholder 104 (shown in FIG. 1), selected to connect one or more of the cardholder's financial accounts to the merchant/fintech 108 via open banking. For example, the merchant/fintech 108 may request the cardholder 104 to link one or more financial accounts with the merchant/fintech service, for example, via the merchant/fintech app 116.

In an example, the cardholder 104 logs into the merchant/fintech app 116. In an embodiment, the cardholder 104 engages with the merchant/fintech app 116 on the cardholder computing device 102 to begin the process of linking the financial account(s) to the merchant/fintech's platform via open banking. For example, upon opening the merchant/fintech app 116 on the cardholder computing device 102, the cardholder 104 is prompted to log in using credentials previously established with the merchant/fintech 108. This login interface may typically be displayed on a display of the cardholder computing device 102, such as the display 220 (shown in FIG. 2), and may include one or more of username/password fields, biometric prompts, or multi-factor authentication (MFA) options. The login interface may be integrated with a backend authentication server (not shown) of the merchant/fintech app 116, which manages user credential verification. The cardholder 104 may enter the cardholder's credentials (e.g., username and password). These credentials may be securely transmitted to the backend server via HTTPS to ensure encrypted communication. The backend server may validate the credentials against stored records. If successful, the backend server may initiate a session token for the cardholder 104, allowing secure access to the merchant/fintech app 116. Following successful authentication, a session is established between the cardholder computing device 102 and the merchant/fintech computing device 108a. The session token may be unique to the login event and may include an expiration period. The session token may be stored temporarily on the cardholder computing device 102. The session token may facilitate subsequent actions to be securely conducted without requiring re-authentication.

Upon login, the cardholder 104 is presented with an option to connect the cardholder's financial account(s) to the merchant/fintech's platform. For example, the merchant/fintech app 116 may present, on the UI 134 of the cardholder computing device 102, an option for the cardholder 104 to connect the cardholder's financial account(s). The option may be implemented as a selectable icon or link within the merchant/fintech app 116. The cardholder 104 may select the option in the merchant/fintech app 116. At 504, upon cardholder selection, the merchant/fintech app 116 may generate a connection request signal, which may be transmitted to the open banking system 130 via the open service API 126.

At 506, upon receiving the account connection request and in response thereto, the merchant/fintech app 116 launches an open banking connection interface on the cardholder computing device 102, via the merchant/fintech app 116. The open banking connection interface is facilitated by a web software development kit (SDK) containing a JSON Web Token (JWT). The JWT, created by the merchant/fintech app 116, encodes specific claims detailing the financial account information being requested, such as account and routing numbers for the cardholder's checking and/or savings accounts, transaction alerts, transaction history, etc. Once generated, the JWT is embedded within the webSDK, which initiates a secure API call to the open service API platform 126, interfacing with the open banking system 130 to request the cardholder's financial account details (i.e., the user consent web low shown in FIG. 5). The API call includes a request for authentication of the cardholder 104. Because the API call is provided with the JWT, the API call is secure. That is, the JWT provides for secure transmission of information between parties as a JSON object.

The cardholder 104, via the cardholder computing device 102, and more particularly, the merchant/fintech app 116, is presented with a login screen of the cardholder's issuer associated with the financial account. The login screen is presented to the cardholder 104 for providing user credentials for the cardholder's financial account, cardholder consent, and cardholder agreement to any presented terms and conditions of the consent. In one particular embodiment, the open service API platform 126 may integrate a user login/consent widget, lightbox, web-redirect, iframe, or the like, in the merchant/fintech app 116 to allow the cardholder 104 to login in to the cardholder's issuer system. The cardholder 104 may be prompted to login and provide the cardholder's consent, at 508. At 510, the cardholder 104 provides login credentials and opts to link the cardholder's financial account(s) to the merchant/fintech 108.

Subsequently, at 512, the merchant/fintech app 116 application initiates a consent request through the open service API 126. The cardholder 104 is redirected, via the merchant/fintech app 116, to the cardholder's financial institution (e.g., the issuer 110) authentication page to verify the cardholder's identity and authorize the requested data access. Once logged in, the cardholder 104 selects the specific checking and/or savings account(s) to be linked to the merchant/fintech 108. The selection is communicated to the open banking system 130 to proceed with authentication. In one embodiment, the cardholder 104 may simply transmit a consent message to the open banking system 130, via the open service API platform 126, for example, by pressing an icon on the user interface of the merchant/fintech app 116. The consent message may include one or more data fields including cardholder consent information indicating consent to one or more account information/data services requested by the merchant/fintech 108 and offered by the interchange network system 106, where each data field corresponds to a respective one of the account information/data services. In another embodiment, the cardholder 104 may select one or more of the requested account information/data services and transmit a consent message including only those data fields corresponding to the cardholder selected account information/data services.

At 514, the open banking system 130 authenticates the cardholder 104 using one or more methods, such as push notifications, one-time passwords, or biometric authentication. In one embodiment, after receiving the financial account login details from the cardholder 104, via the merchant/fintech app 116, the issuer computing system 110a generates an authentication identifier (ID), such as a one-time password (OTP), and transmits it to the cardholder computing device 102. To authenticate the cardholder 104, the issuer computing device 110a requests the authentication ID from the cardholder 104, for example, via the merchant/fintech app 116. If the authentication ID received from the cardholder computing device 102 matches the authentication ID generated by the issuer computing device 110a, the cardholder 104 is considered to be authenticated. Upon successful authentication of the cardholder 104, the issuer 110 provides an authorization code to the merchant/fintech app 116, wherein the authorization code includes a verification that the cardholder 104 has been authenticated by the issuer 10.

In an example embodiment, the authorization code provided to the merchant/fintech app 116 includes a temporary code that the merchant/fintech app 116 can exchange for an access token, such as the authorization token 132 (shown in FIG. 1). The authorization code is a secure means of ensuring that the cardholder 104 has consented to share financial account data without disclosing sensitive login information. The authorization code is single-use, short-lived (usually expiring within a few minutes), and tied to the merchant/fintech app 116 (e.g., via a client ID). The authorization code is transmitted over HTTPS, ensuring that the authorization code is encrypted, preventing interception and use by unauthorized parties. The cardholder 104 is redirected back to the merchant/fintech app 116, with the authorization code. The merchant/fintech computing device 108a (rather than the merchant/fintech app 116) captures the authorization code to exchange it for an access token, such as the authorization token 132. This backend handling prevents unauthorized client-side scripts from accessing the authorization code.

At 516, the merchant/fintech app 116 then redirects the UI to the open banking system 130. In the example, at 518, the merchant/fintech app 116 transmits the authorization code to the open banking system 130. For example, the merchant/fintech app 116 transmits a POST request to the open banking system 130. The request includes the authorization code, a client ID of the merchant/fintech app 116, and a client secret (e.g., unique credentials used to authenticate the merchant/fintech app 116).

The open banking system 130 verifies the request and, based on the authorization code, generates the authorization token 132 and, optionally, a refresh token at 520. The authorization token 132 grants the merchant/fintech app 116 access to the cardholder's financial data as specified in the consent step above. The refresh token (optional) enables token renewal without further cardholder interaction. The open banking system 130 creates an association mapping between the authorization token 132 and the cardholder's consented account details. For example, the open banking system 130 stores the authorization token 132 and the token-to-account mapping data (e.g., in a data mapping table) in a database, such as the database 124.

At 522, the opening banking system 130 transmits the authorization token 132 to the token requester server system 112. In certain embodiments, the authorization token 132 may be forwarded or transmitted directly to the merchant/fintech app 116 by the token requester server system 112 as indicated at 524.

Utilizing the authorization token 132, the token requester server system 112 submits a payment token request to the issuer 110, and more particularly, to the issuer computing device 110a at 526. The payment token request includes a token requester identifier (TRID) associated with the token requester server system 112, the authorization token 132, and the cardholder's consented account details.

Upon receiving the payment token request, the issuer computing device 110a validates the authorization token 132 and subsequently submits a token account receipt request to the token service system 128 at 528. The token account receipt request includes the TRID, the cardholder's consented account details, and optionally, further cardholder information. The token service system 128 may determine (e.g., check, verify, etc.) the eligibility of the cardholder's consented account details for having a payment token generated and associated therewith. For example, the token service system 128 may compare the cardholder's consented account details against a range of enrolled financial accounts that are determined to be eligible for the token service. Alternatively, the token service system 128 may verify that the issuer 110 of the cardholder's consented account details is enrolled in the token service for its associated accounts. As is understood by one skilled in the art, there are various methods for determining the eligibility of a specific financial account for a token service.

If the transaction card is eligible, the token service system 128 generates a token account receipt for the cardholder's consented account details. At 530, the token service system 128 transmits the token account receipt to the issuer computing device 110a, along with a Uniform Resource Locator (URL) directing to the token requester server system 112. The URL is a unique address for the token requester server system 112 on the Internet. In an embodiment, the token requester server system 112 is registered with the token service system 128 as a token requester. As part of the registration process, the token requester server system 112 provides a URL to be used for secure communications. This facilitates reducing fraudulent communications with the token requester server system 112, because the URL is owned and controlled by the token requester. At 532, the issuer computing device 110a communicates with the token requester server system 112 and forwards the token account receipt to the token requester server system 112.

At 534, the token requester server system 112 then communicates with the token service system 128 and transmits a payment token request for the payment token, such as the dPAN 118. The token requester server system 112 includes the token account receipt, which grants permission to the token requester to receive the dPAN associated with the cardholder's financial account(s), in the request. The token service system 128 validates the token account receipt and, upon validation, creates the dPAN 118, linking it to the cardholder's financial account(s).

At 536, the token service system 128 transmits the dPAN 118 to the token requester server system 112. At 538, the token requester server system 112 may then transmit the dPAN 118 to the merchant/fintech 108, such that the dPAN 118 can be used in subsequent financial transactions and/or financial data service requests initiated by the merchant/fintech 108.

In some embodiments, the merchant/fintech 108, the token requester server system 112, and/or the token service system 128 may receive a dPAN revocation request message from one or more of the cardholder 104 (at 540) and the issuer 110 (at 542). The dPAN revocation request message instructs the merchant/fintech 108, the token requester server system 112, and/or the token service system 128 to suspend or otherwise terminate the use of the dPAN 118 by the merchant/fintech 108.

In certain embodiments, the cardholder 104 and/or the issuer 110 may revoke the dPAN 118. That is, the cardholder 104 and/or the issuer 110 may transmit a dPAN revocation request message to one or more of the merchant/fintech 108, the token requester server system 112, and/or the token service system 128 to request that the dPAN 118 be suspended and/or deleted, such that the dPAN 118 can no longer be used to perform transactions and/or retrieve cardholder financial account data. In one embodiment, the cardholder 104 may transmit a dPAN revocation request message via the merchant/fintech app 116. In another embodiment, the cardholder 104 may log in to an issuer app and request that the dPAN 118 be revoked. In such an embodiment, the issuer 110 transmits the dPAN revocation request message to request that the dPAN 118 be suspended and/or deleted on the cardholder's behalf. It is also noted that the issuer 110 may request revocation of the dPAN 118 on its own, rather than a request being initiated by the cardholder 104.

Upon receipt of the dPAN revocation request message, the token service system 128 revokes or deletes the dPAN 118. For example, the token service system 128 may change the status to the dPAN 118 to “suspended,” i.e. a suspended state, or delete the dPAN 118 from the data mapping table in the database 124.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A computing system comprising:
an open banking system comprising:
one or more first processors; and
a first memory comprising first executable instructions, that when executed by the one or more first processors, cause the one or more first processors to:
receive a connection request signal from a financial application running on a cardholder computing device associated with a cardholder, the connection request signal including one or more claims detailing financial account information being requested for a financial account associated with the cardholder;
in response to the connection request signal, launch an open banking connection interface on the cardholder computing device, via the financial application;
present, via the open banking connection interface, a login screen associated with an issuer of the financial account;
receive, from the financial application, an authorization code, the authorization code including a verification that the cardholder is authenticated by the issuer; and
generate an authorization token based on the authorization code; and
a token requester server system comprising:
one or more second processors; and
a second memory comprising second executable instructions, that when executed by the one or more second processors, cause the one or more second processors to:
receive, from the open banking system, the authorization token and the financial account information associated with the financial account;
utilizing the authorization token, transmit a payment token request to the issuer, the payment token request including a token requester identifier (TRID) associated with the token requester server system, the authorization token, and the financial account information; and
receive, from the issuer, a token account receipt; and
a token service system comprising:
one or more third processors; and
a third memory comprising third executable instructions, that when executed by the one or more third processors, cause the one or more third processors to:
receive a token account receipt request from the issuer, the token account receipt request including the TRID and the financial account information;
generate the token account receipt;
transmit the token account receipt to the issuer; and
generate a device primary account number (dPAN),
the second executable instructions further cause the one or more second processors to:
transmit a payment token request to the token service system, the payment token request including the token account receipt; and
in response, receive the dPAN from the token service system.

2. The computing system in accordance with claim 1,
the second executable instructions further cause the one or more second processors to transmit the authorization token to the financial application running on the cardholder computing device.

3. The computing system in accordance with claim 1,
the second executable instructions further cause the one or more second processors to transmit the dPAN to the financial application running on the cardholder computing device.

4. The computing system in accordance with claim 1, further comprising:
a database,
the first executable instructions further cause the one or more first processors, as part of the step to generate the authorization token, to:
store the authorization token in a data mapping table in the database; and
associate the authorization token to the financial account information.

5. The computing system in accordance with claim 4,
the second executable instructions further cause the one or more second processors to receive a dPAN revocation request message from the cardholder computing device.

6. The computing system in accordance with claim 5, the third executable instructions further cause the one or more third processors to perform an operation comprising one of the following: setting a status of the dPAN in the data mapping table to a suspended state and deleting the dPAN from the data mapping table.

7. The computing system in accordance with claim 4,
the third executable instructions further cause the one or more third processors to receive a dPAN revocation request message from the issuer.

8. The computing system in accordance with claim 7,
the third executable instructions further cause the one or more third processors to perform an operation comprising one of the following: setting a status of the dPAN in the data mapping table to a suspended state and deleting the dPAN from the data mapping table.

9. A method performed by a computing system including an open banking system, a token requester server system, and a token service system, the method comprising:
receiving, by the open banking system, a connection request signal from a financial application running on a cardholder computing device associated with a cardholder, the connection request signal including one or more claims detailing financial account information being requested for a financial account associated with the cardholder;
in response to the connection request signal, launching, by the open banking system, an open banking connection interface on the cardholder computing device, via the financial application;
presenting, by the open banking system via the open banking connection interface, a login screen associated with an issuer of the financial account;
receiving, by the open banking system from the financial application, an authorization code, the authorization code including a verification that the cardholder is authenticated by the issuer;
generating, by the open banking system, an authorization token based on the authorization code;
receiving, by the token requester server system from the open banking system, the authorization token and the financial account information associated with the financial account;
utilizing the authorization token, transmitting, by the token requester server system, a payment token request to the issuer, the payment token request including a token requester identifier (TRID) associated with the token requester server system, the authorization token, and the financial account information; and
receiving, by the token requester server system from the issuer, a token account receipt;
receiving, by the token service system, a token account receipt request from the issuer, the token account receipt request including the TRID and the financial account information;
generating, by the token service system, the token account receipt;
transmitting, by the token service system, the token account receipt to the issuer;
generating, by the token service system, a device primary account number (dPAN);
transmitting, by the token requester server system, a payment token request to the token service system, the payment token request including the token account receipt; and
in response, receiving, by the token requester server system, the dPAN from the token service system.

10. The method in accordance with claim 9, further comprising:
transmitting, by the token requester server system, the authorization token to the financial application running on the cardholder computing device.

11. The method in accordance with claim 9, further comprising:
transmitting, by the token requester server system, the dPAN to the financial application running on the cardholder computing device.

12. The method in accordance with claim 9, further comprising, as part of the step of generating the authorization token:
storing, by the open banking system, the authorization token in a data mapping table in a database; and
associating, by the open banking system, the authorization token to the financial account information.

13. The method in accordance with claim 12, further comprising:
receiving, by the token requester server system, a dPAN revocation request message from the cardholder computing device.

14. The method in accordance with claim 13, further comprising:
performing, by the token service system, an operation comprising one of the following: setting a status of the dPAN in the data mapping table to a suspended state and deleting the dPAN from the data mapping table.

15. The method in accordance with claim 12, further comprising:
receiving, by the token service system, a dPAN revocation request message from the issuer.

16. The method in accordance with claim 15, further comprising:
performing, by the token service system, an operation comprising one of the following: setting a status of the dPAN in the data mapping table to a suspended state and deleting the dPAN from the data mapping table.

17. A non-transitory computer-readable storage media having computer-executable instructions stored thereon, wherein when executed by one or more processors, the computer-executable instructions cause the one or more processors to:
receive, by an open banking system, a connection request signal from a financial application running on a cardholder computing device associated with a cardholder, the connection request signal including one or more claims detailing financial account information being requested for a financial account associated with the cardholder;
in response to the connection request signal, launch, by the open banking system, an open banking connection interface on the cardholder computing device, via the financial application;
present, by the open banking system via the open banking connection interface, a login screen associated with an issuer of the financial account;
receive, by the open banking system from the financial application, an authorization code, the authorization code including a verification that the cardholder is authenticated by the issuer;
generate, by the open banking system, an authorization token based on the authorization code;
receive, by a token requester server system from the open banking system, the authorization token and the financial account information associated with the financial account;
utilizing the authorization token, transmit, by the token requester server system, a payment token request to the issuer, the payment token request including a token requester identifier (TRID) associated with the token requester server system, the authorization token, and the financial account information; and
receive, by the token requester server system from the issuer, a token account receipt;
receive, by a token service system, a token account receipt request from the issuer, the token account receipt request including the TRID and the financial account information;
generate, by the token service system, the token account receipt;
transmit, by the token service system, the token account receipt to the issuer;
generate, by the token service system, a device primary account number (dPAN);
transmit, by the token requester server system, a payment token request to the token service system, the payment token request including the token account receipt; and
in response, receive, by the token requester server system, the dPAN from the token service system.

18. The non-transitory computer-readable storage media of claim 17, wherein when executed by the one or more processors, the computer-executable instructions further cause the one or more processors to:
transmit, by the token requester server system, the authorization token to the financial application running on the cardholder computing device.

19. The non-transitory computer-readable storage media of claim 17, wherein when executed by the one or more processors, the computer-executable instructions further cause the one or more processors to:
transmit, by the token requester server system, the dPAN to the financial application running on the cardholder computing device.

20. The non-transitory computer-readable storage media of claim 17, wherein when executed by the one or more processors, the computer-executable instructions further cause the one or more processors to:
store, by the open banking system, the authorization token in a data mapping table in a database; and
associate, by the open banking system, the authorization token to the financial account information.
